(19) United States
(12) Patent Application Publication
(10) Pub. No.: US 2004/0003394 A1
(43) Pub. Date: Jan. 1, 2004

(54) System for automatically matching video with ratings information

(76) Inventor: Arun Ramaswamy, Tampa, FL (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/185,734

(22) Filed: Jul. 1, 2002

(51) Int. Cl. H04N 7/16; H04N 7/173; H04N 5/04; H04N 9/44

(52) U.S. Cl. 725/28; 725/109; 348/500

(57) ABSTRACT

A system for independently capturing video content from various video content sources and ratings data independently. The video content and ratings data is stored with metadata so that the video content and ratings data is searchable. A synchronization engine automatically links the video content to the rating data. As such, selected video content and corresponding ratings data is presented to a user in a contiguous format in a synchronized manner over different platforms including the Internet.

### BACKGROUND OF THE INVENTION

1. Field of the Invention

The present invention relates to a video presentation system and more particularly to a system in which video content and ratings data pertaining to the video content are independently captured, matched, and made available to an end user in a synchronized manner.

2. Description of the Related Art

Television ratings systems have been around for decades. Such television rating systems are based upon electronic measurement systems which measure what television programs are being tuned and the demographics of the audience watching. For example, Nielsen Media Research provides ratings in the United States as well as Canada based upon an electronic measurement system known as a Nielsen People Meter. The People Meters are placed in a random sample of approximately 5000 households, randomly selected and recruited. One People Meter is used for each television set in the sample household. The People Meter electronically monitors channel changes within each household and the time associated with such channel changes. The time and channel change data is then correlated with a database formed essentially as a television guide with provides the local channels and time slots for available television programs, thus enabling the channel changes to be correlated with specific television programs.

The People Meter is also able to gather demographic information. More particularly, each family member in a sample household is assigned a personal viewing button on the People Meter. Each button is correlated with the age and gender of each person in the household. When the television set is turned on, the person watching television then selects their assigned button. The system is then able to correlate the demographic data with the selected television program. Alternatively, electronic measurement systems are used which strictly monitor channel changes with the demographic information being collected manually in the form of a diary.

The tuning data for all metered samples is locally stored until automatically retrieved and processed for release to the television industry, for example, on a daily basis. Such rating information is useful for various business determinations including setting the cost of commercial advertising time.

For various types of applications, it would be helpful to simplify the correlation of video content with the associated television ratings data. Moreover, video content and ratings data is not known to be searchable. Thus, with present technology, the video content and ratings data must be searched manually. Once the desired video content or ratings content is located, the corresponding video or ratings data must be retrieved separately making the process cumbersome. Unfortunately, current systems only provide for separate comparison of the video content and ratings data.

Thus there is a need for a system for enabling video content and ratings data to be captured independently and archived so that the stored video content is searchable and in which the video content and ratings data is automatically matched and presented to the user in a display in a side-by-side format in a synchronized manner.

### SUMMARY OF THE INVENTION

Briefly, the present invention relates to a system for independently capturing video content from various video content sources and ratings data independently. The video content and ratings data is stored with metadata so that the video content and ratings data is searchable. A synchronization engine automatically links the video content to the rating data. As such, selected video content and corresponding ratings data is presented to a user in a contiguous format in a synchronized manner over different platforms including the Internet.

### DESCRIPTION OF THE DRAWINGS

These and other advantages of the present invention will be readily understood with reference to the following specification and attaching drawings wherein:

FIG. 1 is a high-level block diagram of the system for automatically matching video content with ratings information in accordance with the present invention.

FIG. 2 is a block diagram of the video capture and the ratings capture subsystems in accordance with the present invention.

FIG. 3 is a block diagram illustrating the presentation of the video content and ratings data in a side-by-side format in accordance with one aspect of the invention.

FIG.4 is a block diagram illustrating (i.e. client's side) synchronization module or sync engine in accordance with the present invention.

FIG. 5 is a flow diagram for the sync engine in accordance with the present invention.

FIG. 6 is similar to FIG. 4 but illustrating the sync engine on the server side.

### DETAILED DESCRIPTION

The present invention relates to a system for independently capturing and storing video contents and ratings data. The video content and ratings data is stored with embedded parameters which unables the video content and ratings data to be searched. The video content is linked to the corresponding rating data which allows the video content to be presented with the ratings data on a side-by-side basis on various platforms, such as the World Wide Web, for example, by way of wireless connection by way of a personal digital assistant (PDA).

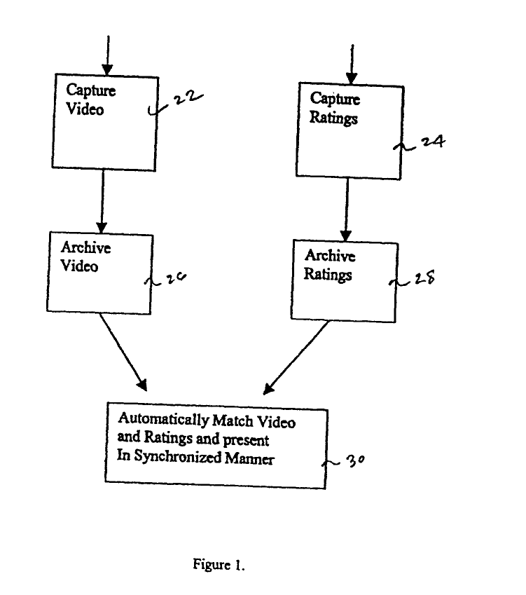

Referring to FIG. 1, the overall process for the system in accordance with the present invention is illustrated. As shown, video content and ratings data are captured as indicated in steps 22 and 24. In applications where the copyright rights for the video content and the ratings data are owned by different copyright owners, the video content and ratings data are captured independently. In situations where the copyrights for both video content and the ratings data are owned by the same entity, the steps of capturing the video content and ratings data may be performed by the same server.

In accordance with one aspect of the invention, both the video content and the ratings data are archived in a searchable format in steps 26 and 28. In particular, metadata is embedded into the video content as well as the ratings data to enable the video content and ratings data to be searched as a function of the embedded parameters.

In accordance with another important aspect of the invention, the video content and ratings data is automatically matched in step 30 and presented on a platform, in a synchronized manner. As such, the system provides searchable video content and ratings data and automatically matches the video content with the ratings data and presents the video content and corresponding ratings data in a side-by-side format over various known platforms, such as the World Wide Web.

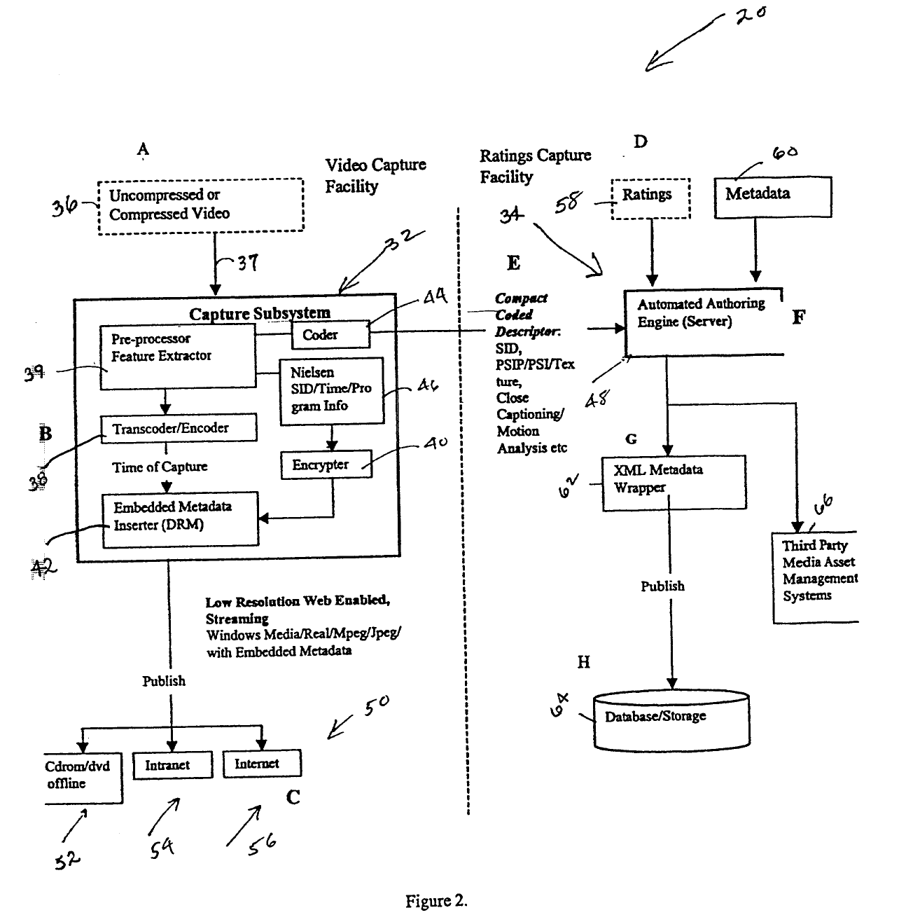

FIG. 2 is a block diagram of the system in accordance with the present invention illustrating a video content capture subsystem 32 and a ratings capture subsystem 34. The video content capture subsystem 32 includes a source of video content 36. The video content source may include sources of video content in various formats, such as Advanced Television Standards Committee (ATSC), European Digital Video Broadcasting (DVB), Moving Pictures Experts Group (MPEG). The audio/video 36 content may be compressed or uncompressed and captured from either a terrestrial broadcast, satellite or cable feed. The video content may also be archived video from a video tape source.

The video content, known to be broadcast with an embedded time stamp and, for example, PSIP (Program and System Information Protocol) data, is applied to the video content capture system 32, as indicated by an arrow 37. The video capture subsystem 32 may be implemented by one or more servers and includes a preprocessor feature extractor 39, a transcoder encoder 38, an encrypter 40 and an embedded metadata inserter 42.

The preprocessor feature extractor 39 separates or tunes the program of interest and extracts searchable parameters from the content. The searchable content falls into three main categories: embedded information; content information; and encoding parameters.

Embedded information for uncompressed sources of video content includes metadata, such as close caption data, which may have been embedded in the vertical blanking intervals of the video content, or alternatively audio watermarks. For compressed video content signals, the embedded information may comprise information transported in the user data fields of the compressed video, auxiliary data fields of MPEG audio as well as AC3 and separate data channels. The embedded information may comprise information identifying the program of interest, such as the program identification (ID) date and time, for example.

Content information includes PSIP, creator/asset name/copyright information, as well as other information regarding the content. Encoding parameters include structural information using spatial/temporal components of the video content, scene cuts, segmentation and motion tracking. Encoding parameters may also include low level features, such as texture/colors, conceptual information, interaction between objects in the video and events in the video etc. Various systems are known for extracting embedded data from video content. For example, U.S. Pat. No. 6,313,886 (incorporated herein by reference) discloses a system for extracting PSIP data from a video signal. Other systems are known for extracting other types of data embedded in video content, such as closed captioning data motion analysis and the like.

Feature data, such as the PSIP data, close caption data, etc. is extracted from the video content 36 by the preprocessor feature extractor 37 and directed to the coder 44 which encodes the extracted data in a format suitable for use in the ratings capture subsystem 34, discussed below. Embedded information as well as content information, generally identified with the reference numeral 46, is extracted by the preprocessor feature extractor 37 and directed to the embedded metadata inserter 42, for example, by way of an encrypter 40, which encrypts the embedded information and content information.

The transcoder/encoder 38 processes the video content into a format suitable for replay on other platforms. For example, the transcoder/encoder 38 may be used to convert relatively high resolution video content (i.e. standard definition and high definition signals at 19.39 Mbps) to relatively low resolution/low bandwidth, for use, for example, in wireless platforms, such as 340×240 at 200 Kbps into various formats, such as Windows Media, Real, Quick Time or JPEG format in real time. In the case of uncompressed video content, the transcoder/encoder 38 compresses the video content to a relatively low resolution/low bandwidth rate suitable for wireless platforms as discussed above.

The encrypted embedded information and content information is embedded into the low bit streams, produced by the transcoder/encoder 38 as metadata. The metadata may be embedded as either a systems layer where information is not compressed or may be embedded in the compression layer where the metadata may be compressed and stored in inaudible audio codes or digital watermarks. The embedded metadata is used for various purposes including digital rights management.

The embedded metadata may include the program name, program source as well as the time codes in the audio portion which identify the time of transmission. The embedded metadata may also include the date/time of capture in terms of system time ProgramStartTime_{c}. The ProgramStartTime_{c} may be either the actual time of capture or alternatively the first received time code, extracted from the audio portion or the video of the received video content 36. Typically these time codes are embedded in the video content during transmission. The low resolution streaming format bit streams are published to remote storage devices, such as a remote video server, generally identified with the reference numeral 50. The remote storage devices may include CD-ROM/DVD storage devices 52 or storage area networks on an Intranet 54 or the Internet 56.

The coder 44 converts the embedded information and content information from the preprocessor feature extractor 37 into a coded representation, hereinafter called the code descriptor, using standards, such as MPEG-7. The coded descriptor is either published or FTPd (i.e. transmitted by file transfer protocol) to an authoring server 48, which forms part of the ratings capture subsystem 34.

The ratings capture subsystem 34 includes a source of ratings data 58, for example, audience measurement data, captured either directly from sample homes or from ratings data collection servers (not shown) along with a source of metadata 60, which may include program identification information. The ratings data 58 and corresponding metadata 60 is applied to the automated authoring engine 48 along with the coded descriptor, described above. Ratings data 58 is produced and time stamped for each minute of the program and is used to match the video content 36 with the ratings data. The metadata 60 associated with the ratings data 58 may include program identification information.

The automated authoring engine 48 takes the ratings data 58, the ratings metadata 60, as well as the coded descriptor from the video content subsystem 32 and generates a metadata wrapper 62, which may be XML based. The metadata wrapper 62 associates the ratings data with other video metadata, such as description, close caption, etc. to each temporal point in the video content. In particular, the metadata wrapper 62 may include the following variables, used in the matching element discussed below. These variables include:

start time of the program, ProgramStartTime_{R}

total number of ratings elements, TotalElements

increments of time elements, DeltaTime_{R}

XML is especially adapted for data presentation because it provides for definition of customized tags and values. XML also allows for linking ratings and other metadata to temporal and spatial points in the video content. The metadata wrapper 62 may be associated with different formats of video (i.e. high resolution MPEG, Windows Media, Real JPEG, etc.) independent of the media type and thus may be considered “out of band”.

The metadata wrapper 62 is published to a database 64 implemented by a ratings server. The metadata wrapper 62 may also be published to third party databases and media asset management systems 66 serving bigger server farms.

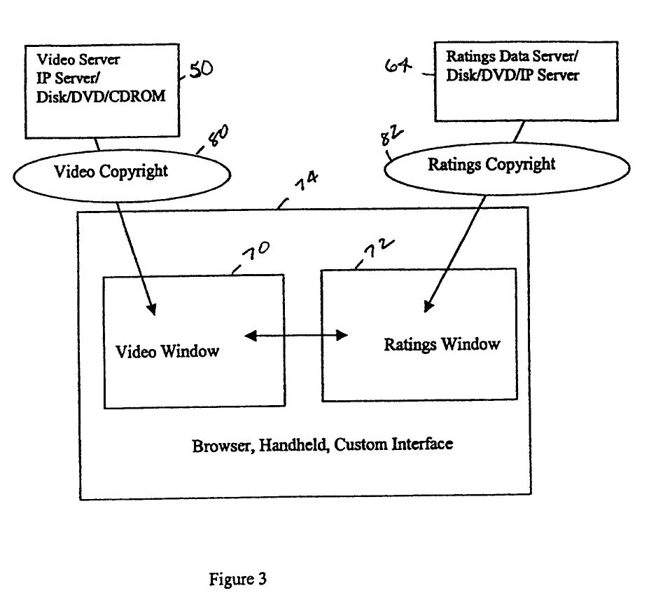

FIG. 3 illustrates a high-level presentation system for presenting searchable video and ratings content to various consumer platforms which enable the video and ratings content to be searched, selected and displayed in a video display window 70 along side the corresponding ratings data in a ratings display window 72 on a consumer platform 74. Alternatively, the ratings data and the video content can be displayed in the same window in which the ratings data is superimposed on the video content. In particular, the consumer platform 74 requires only a standard web browser for presentation.

The consumer platform 74, for example, a wireless personal digital assistant, may be connected to the video server 50 and ratings data server 64 by way of digital rights management subsystems 80 and 82, respectively. These digital right management subsystems 80 and 82 are known and only allow access to the servers 76 and 78 by end users having permission from the copyright owner. The video content digital rights management 80 may be implemented as a separate server or may be incorporated into the video content server 50. Similarly, the ratings digital right management subsystem 82 may also be implemented as separate server 82 or may be incorporated into the server 64. If the user is authorized by the copyright owner, the video content digital rights management system 80 as well as the ratings data digital rights management system 82 allow the end user platform 74 to access the server 76 and 78.

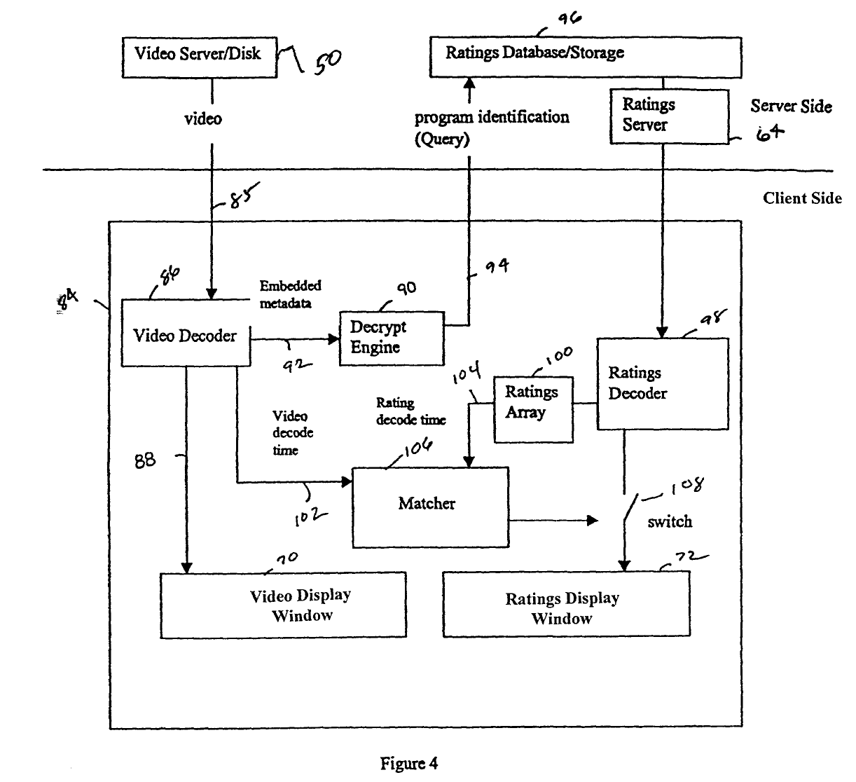

In accordance with the preferred embodiment, the end user can search either or both of the video content and the ratings data using searchable parameters. Once the video or rating content is selected, the video content is displayed in the video window 70. A synchronization engine or module (FIG. 4) is then used to synchronize the corresponding ratings data with the video content and display it in the ratings display window 72. The synchronization module can be implemented as a self-contained active x object, a stand-alone software player, an executable Java applet, an HTML page or a combination of the above.

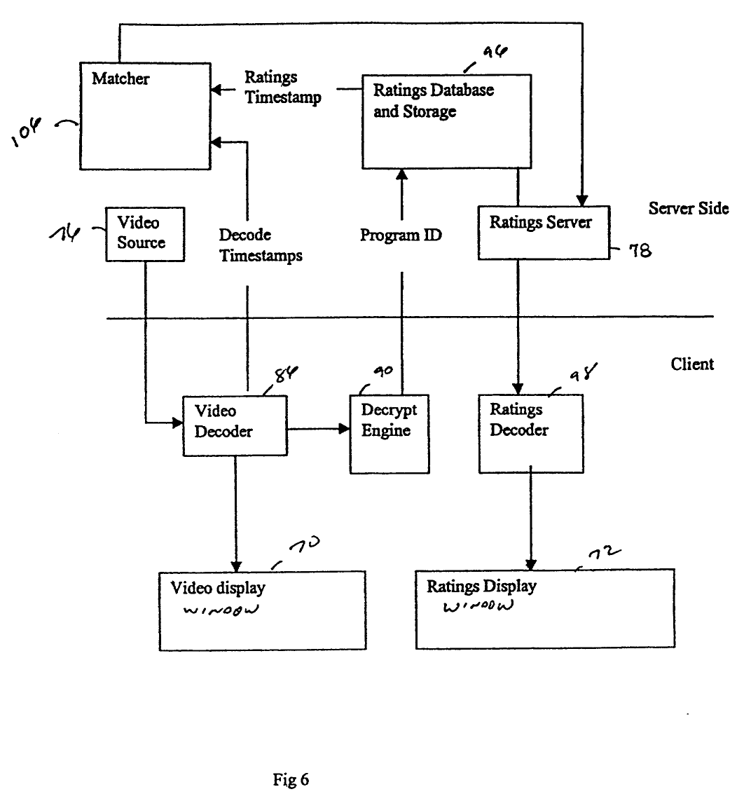

Two embodiments of the synchronization module 84 are contemplated. In one embodiment, illustrated in FIG. 4, the synchronization module 84 is implemented on the client side. In an alternate embodiment illustrated in FIG. 6, a matcher portion of the synchronization module 84 is implemented on the server side.

Turning to FIG. 4, video content from the video server 50 or from a hard drive is pushed to a video decoder 86 within the synchronization module 84 along the path identified with the reference numeral 85. The video decoder 86 decodes the video content and separates the video data from the embedded metadata. The video data is pushed to the video display window 70 and displayed. The embedded metadata which, as discussed above, is encrypted, is applied to a decryption engine 90, where it is decrypted. The video decode time stamp 102, decoded by the video decoder 86, is applied to a matcher 106. The decrypted metadata is used to make a query to a ratings database 96 using content information as the key to retrieve ratings data, as indicated by the data path 92. The ratings data is then pushed to a ratings server 78, which may be implemented as a HTTP or an RTSP server.

The ratings data may be delivered as XML data or sent back as HTML pages. In the case of HTML pages, an XSL engine may be used to transform the XML data to a suitable format. The ratings data is decoded by a ratings decoder 98 and stored in a ratings array 100 which pushes rating decode time stamps to the matcher 106, which, in turn, are used to match or index video content by way of the video decode time stamps along data path 102. Both the rating decode time stamps and video decode time stamps are compared by the matcher 106 utilizing an exemplary matching algorithm provided in the Appendix. If the video decode time stamps correspond to the rating decode time stamps, the matcher 106 supplies the decoded ratings data from the ratings decoder 98 to the ratings display window 72 by way of a switch 108.

As mentioned above, FIG. 6 is an alternate embodiment of the synchronization module. As shown, like reference numerals are used to denote like devices. As shown, the only difference between the synchronization module illustrated in FIGS. 4 and 6 is that in FIG. 6 the matcher 106 is implemented on the server side of the system otherwise the two systems are virtually the same.

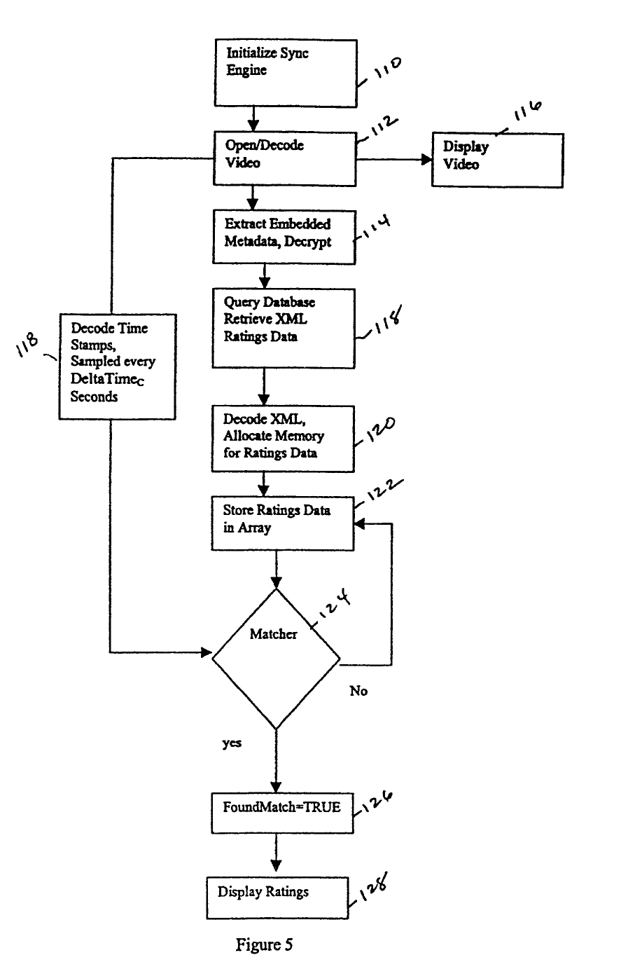

A flow diagram is illustrated in FIG. 5. Referring to FIG. 5, initially in step 110, the synchronization module 84 (FIG. 4) is initialized. Essentially, in this step, the ratings array 100 is cleared and the video random access memory (RAM) feeding the video display window 70 and the ratings display window 72 are cleared in step 110. After the synchronization module 84 is initialized in step 110, the video from the video server 76 with the embedded metadata is decoded in step 112. The metadata is extracted from the video content and decrypted in step 114. The video content is displayed in the video display window 70 in step 116. The decode time stamp is sampled every delta time seconds and directed to the matcher 106 (FIGS. 4 and 6) in step 118. The decrypted metadata from the video content is used to query the ratings database 96 in step 118 to retrieve ratings data. The ratings data is decoded in step 120 and stored in the ratings array 100 in step 122. The ratings decode time stamps are applied to the matcher 106 along with the video decode time stamps. If the matcher determines that there is a match according to the matching algorithm as set forth in the Appendix as determined in step 124, the system indicates a match in step 126 and displays the ratings in step 128 otherwise the ratings are circled back to step 120.

Obviously, many modifications and variations of the present invention are possible in light of the above teachings. Thus, it is to be understood that, within the scope of the appended claims, the invention may be practiced otherwise than as specifically described above.

What is claimed:

1. A system for capturing video data that is linked to ratings data which automatically matches the video content to the corresponding ratings data for presentation to an end user in a synchronized manner, the system comprising:
a video capture subsystem for capturing and storing video content from various sources;
a ratings capture subsystem for capturing and storing ratings data and automatically linking said ratings data to corresponding video content; and
a presentation system configured to present the video content and ratings data in a synchronized manner.

2. The system as recited in claim 1, wherein said video capture subsystem comprises;
a parameter extractor for extracting predetermined parameters from video content in a first video format;
a transcoder for converting said video content in said first format to a second format; and
metadata inserter for embedding said extracted parameters into said video content in said second video format.

3. The system as recited in claim 2, wherein said video capture subsystem further includes an encrypter for encrypting said predetermined extracted parameters before said extracted parameters are embedded into said video content in said second video format.

4. The system as recited in claim 2, wherein said parameters include embedded information.

5. The system as recited in claim 4, wherein said second video format is uncompressed.

6. The system as recited in claim 5, wherein said parameters include close caption data.

7. The system as recite din claim 6, wherein said close caption data is embedded in said vertical blanking interval (VBI).

8. The system as recited in claim 4, wherein said second video format is compressed.

9. The system as recited in claim 8, wherein said parameters include data in the user data fields of the compressed video.

10. The system as recited in claim 8, wherein the parameters include data contained in auxiliary data fields of MPEG audio.

11. The system as recited in claim 8, wherein the parameter includes information relating to a predetermined program.

12. The system as recited in claim 11, wherein said information includes program identification (ID).

13. The system as recited in claim 11, wherein said information includes temporal information relating to a predetermined program.

14. The system as recited in claim 13, wherein said temporal information relates to the data that a program was broadcast.

15. The system as recited in claim 13, wherein said temporal information relates to the time the program was broadcast.

16. The system as recited in claim 2, wherein said parameters include content information.

17. The system as recited in claim 16, wherein said content information relates to PSIP data.

18. The system as recited in claim 16, wherein said content information relates to copyright information.

19. The system as recited in claim 16, wherein said content information relates to asset name.

20. The system as recited in claim 16, wherein said content information relates to creator.

21. The system as recited in claim 21, wherein said parameters include encoding parameters.

22. The system as recited in claim 21, wherein said parameters relate to structural information of spatial temporal components.

23. The system as recited in claim 1, wherein the system for presenting the selected video content and the corresponding ratings data includes a synchronization module.

24. The system as recited in claim 1, wherein said synchronization module includes a system for decoding video content and ratings data and generating a video decode time stamp and a ratings decode time stamp which are compared, the results of which are used to synchronize ratings data with video content.

25. The system as recited in claim 24, wherein said synchronization module includes a video decoder which extracts embedded metadata from video content which is used to retrieve ratings data.

26. The system as recited in claim 1, wherein said video capture subsystem is configured to enable embedding of searchable parameters in said video content which enable said video content to be searched by an end user.

27. The system as recited in claim 1, wherein said ratings capture subsystem is configured to enable embedding of searchable parameters in said ratings data which enable said ratings data to be searched by an end user.

28. A system for presenting video content and ratings data in a synchronized manner, the system comprising:
a video subsystem which includes stored video content;
a ratings subsystem which includes stored ratings data; and
a synchronization engine for synchronizing playback of video content with its corresponding ratings data.

29. The system as recited in claim 28, wherein said system is configured such that video content and ratings data are played back in contiguous windows.

30. The system as recited in claim 28, wherein said system is configured such that said ratings data is superimposed in said video content in a single window.

31. The system as recited in claim 28, wherein said stored video content includes embedded searchable parameters which enable said video content to be searched by an end user.

32. The system as recited in claim 28, wherein said stored ratings data includes embedded searchable parameters which enable said ratings data to be searched by an end user.

33. A process for associating ratings data with corresponding video content, the process comprising the steps of:
a) storing video content;
b) storing ratings data; and
c) automatically linking said ratings data with said video content.

34. The process as recited in claim 33, further including a step:
d) presenting the video content and ratings data in a synchronized manner.

35. The process as recited in claim 34, wherein the video content and ratings data is presented in contiguous windows.

36. The process as recited in claim 34, wherein the ratings data is superimposed on said video content in the same window.

37. The process as recited in, claim 33, wherein said video content is stored with searchable parameters which enable said video content to be searched by an end user.

38. The process as recited in claim 33, wherein said ratings data is stored with searchable parameters which enable said ratings data to be searched by an end user.

39. The system as recited in claim 1, wherein said ratings capture subsystem includes an automated authoring engine for generating metadata for said ratings data.

40. The system as recited in claim 39, wherein said automatic authoring engine generates a metadata wrapper for the ratings data which corresponds temporally to said video content.

41. The system as recited in claim 39, wherein said metadata wrapper includes the start time of the program.

42. The system as recited in claim 39, wherein said metadata wrapper includes a total number of ratings elements.

43. The system as recited in claim 39, wherein said metadata wrapper includes increments of time elements.

44. The system as recited in claim 40, wherein said metadata wrapper in XML based.
